(19) United States
(12) Patent Application Publication
(10) Pub. No.: US 2025/0348090 A1
(43) Pub. Date: Nov. 13, 2025

(54) UNMANNED AERIAL VEHICLE FORMATION CONTROL SYSTEM AND METHOD THEREFOR

(71) Applicant: GWANGJU INSTITUTE OF SCIENCE AND TECHNOLOGY, Gwangju (KR)

(72) Inventors: Nam Jin PARK, Gwangju (KR); Hyo Sung AHN, Gwangju (KR); Ki Hyeon KIM, Gwangju (KR); Jeong Min MA, Gwangju (KR); Jun Oh PARK, Gwangju (KR); Jin Hee SON, Gwangju (KR); Hyung Gohn LEE, Gwangju (KR)

(21) Appl. No.: 18/293,420

(22) PCT Filed: Jun. 14, 2022
(86) PCT No.: PCT/KR2022/008415

§ 371 Date: May 28, 2025

(30) Foreign Application Priority Data
Aug. 30, 2021 (KR) 10-2021-0114693

(51) Int. Cl. G05D 1/695; G05D 1/24; G05D 1/698; G05D 109/20

(52) U.S. Cl. CPC G05D 1/695; G05D 1/24; G05D 1/6985; G05D 2109/20

(57) ABSTRACT

An embodiment of the present disclosure provides an unmanned aerial vehicle formation control system that performs formation control of a plurality of unmanned aerial vehicles, the system including a data processing unit that receives the location data and distance data of the unmanned aerial vehicles and provides the received location data and distance data to other unmanned aerial vehicles belonging to a formation of the unmanned aerial vehicles; a formation alignment unit that selectively uses the location data and the distance data to align the formation of the unmanned aerial vehicles; and a formation error determination unit that calculates an overall formation error value due to formation alignment mismatch based on the location data of the unmanned aerial vehicle, and compares the formation error value with a preset allowable threshold value to determine whether a formation error of the unmanned aerial vehicle has occurred, wherein when it is determined that the formation error has occurred, the formation alignment unit realigns the unmanned air vehicle based on the location data of the unmanned air vehicle, and combines location data-based formation control of the unmanned air vehicle and distance data-based formation control of the unmanned air vehicle to align the unmanned air vehicle so as to maintain a constant formation form using two of the distance data.

### TECHNICAL FIELD

The present disclosure relates to an unmanned aerial vehicle formation control system and a method thereof, and more particularly, to an unmanned aerial vehicle formation control system capable of aligning the formation of unmanned aerial vehicles based on the location data and distance data of the unmanned aerial vehicles, and minimizing a formation error, and a method thereof.

### BACKGROUND ART

In recent years, as the field of use of unmanned aerial vehicles has expanded, research and development actively carried out around the world. An unmanned aerial vehicle is an aerial vehicle that flies through remote control or automatic piloting without a human on board to control the aerial vehicle. Early unmanned aerial vehicles were developed for military purposes and used as reconnaissance and bombers, but in recent years, they have been widely used for purposes such as agriculture, photography, leisure, delivery, and disaster response.

Additionally, as unmanned aerial vehicles are converging with IT technology, a plurality of unmanned aerial vehicles form a formation to perform more complex purposes.

In particular, as the agricultural cultivation area and scale of farmland at home and abroad are increasing, the demand for formation flight technology for agricultural unmanned aerial vehicles is increasing. In this day and age, the agricultural unmanned aerial vehicles may be equipped with nozzles for spraying pesticides to perform pest control work. Therefore, it is necessary for agricultural unmanned aerial vehicles to form an accurate formation and efficiently spray pesticides on farmland without overlapping the nozzles of respective unmanned aerial vehicles.

Meanwhile, as one of the related arts, a method of controlling a formation flight through arranging location-based sensors on a plurality of unmanned aerial vehicles, and acquiring the location coordinates of respective unmanned aerial vehicles is disclosed.

FIG. 1 is a diagram showing an example of formation control of agricultural unmanned aerial vehicles using location coordinates according to the related art.

Referring to FIG. 1, an unmanned aerial vehicle formation control system in the related art determines a formation form based on the location data of a plurality of unmanned aerial vehicles (D1, D2, D3). For example, location data may be the coordinates of a global positioning system (GPS) that calculates a current location through receiving signals transmitted from artificial satellites.

Each unmanned aerial vehicle provides GPS coordinates in real time to the unmanned aerial vehicle formation control system. The unmanned aerial vehicle formation control system checks the GPS coordinates, and provides each unmanned aerial vehicle with location data where the unmanned aerial vehicle should be located. At this time, the location data where the unmanned aerial vehicle should be located is determined based on a formation form of the unmanned aerial vehicle that is already registered or input in real time.

Therefore, in a formation flight (A1) of agricultural unmanned aerial vehicles, each agricultural unmanned aerial vehicle flies in formation based on the provided location data, so that a control overlap zone 10 or a no-control zone 20 occurs. In the formation flight (A1) of agricultural unmanned aerial vehicles, the agricultural unmanned aerial vehicles may fly in an ideal formation to efficiently manage farmland.

However, in the formation flight of the unmanned aerial vehicles using GPS coordinates, there is a problem in that an error of at least ±1 m is usually generated even in the stabilization section. In addition, as the number of unmanned aerial vehicles that form a formation increases, GPS coordinate errors of respective unmanned aerial vehicles may accumulate and increase exponentially, causing a larger error.

According to the related art, the unmanned aerial vehicle formation control system based on GPS coordinates has no choice but to perform a formation flight (A2) of agricultural unmanned aerial vehicles with GPS coordinate errors. Accordingly, the location coordinates of the plurality of unmanned aerial vehicles (D1, D2, D3) are moved by a GPS coordinate error value (err1), and thus the formation control of the unmanned aerial vehicles is not accurately performed.

Furthermore, in the related art, the control overlap zone 10 is generated due to the location coordinates (D₁(x₁(t)−err₁(t), y₁(t)) of the aerial vehicle (D1) moved by the GPS coordinate error value (err1) and the location coordinates (D₂(x₂(t)+err₂(t), y₂(t)) of the unmanned aerial vehicle (D2) moved by the GPS coordinate error value (err2).

In addition, there is a problem in that the no-control zone 20 is generated due to the location coordinates (D₁(x₁ (t)−err₁(t), y₁(t)) of the unmanned aerial vehicle (D1) moved by the GPS coordinate error value (err₁) and the location coordinates (D₃(x₃ (t)+err₃(t), y₃(t)) of the unmanned aerial vehicle (D3) moved by the GPS coordinate error value (err3).

In this case, there is an inconvenience in that crops in the control overlap zone 10 caused by the GPS coordinate errors must be discarded or undergo additional cleaning due to control exceeding a reference value.

Furthermore, crops in the no-control zone 20 caused by the GPS coordinate errors may not be properly controlled, and the quality of crops may deteriorate due to pests. Farmland owners may incur financial damage due to the extensive cost and time required due to inefficient pest control.

Therefore, there is a need to develop a formation control system for unmanned aerial vehicles that can improve the precision of formation alignment through solving the problem of accumulating GPS coordinate errors of a plurality of unmanned aerial vehicles that form a formation.

### DISCLOSURE OF INVENTION

### Technical Problem

A technical problem to be solved by the present disclosure is to provide an unmanned aerial vehicle formation control system capable of aligning the formation of unmanned aerial vehicles based on the location data and distance data of the unmanned aerial vehicles, and minimizing a formation error, and a method thereof.

Furthermore, a technical problem to be solved by the present disclosure is to provide an unmanned aerial vehicle formation control system capable of automatically aligning the formation of unmanned aerial vehicles with a simple configuration and at low cost, and minimizing a formation error, and a method thereof.

In addition, a technical problem to be solved by the present disclosure is to provide an unmanned aerial vehicle formation control system capable of determining in real time whether a formation error has occurred based on the location data of unmanned aerial vehicles, and a method thereof.

In addition, a technical problem to be solved by the present disclosure is to provide an unmanned aerial vehicle formation control system capable of automatically performing formation realignment on unmanned aerial vehicles when a formation error occurs, thereby more accurately maintaining a formation.

### Technical Solution

In order to solve the foregoing technical problems, an embodiment of the present disclosure provides an unmanned aerial vehicle formation control system that performs formation control of a plurality of unmanned aerial vehicles, the system including a data processing unit that receives the location data and distance data of the unmanned aerial vehicles and provides the received location data and distance data to other unmanned aerial vehicles belonging to a formation of the unmanned aerial vehicles; a formation alignment unit that selectively uses the location data and the distance data to align the formation of the unmanned aerial vehicles; and a formation error determination unit that calculates an overall formation error value due to formation alignment mismatch based on the location data of the unmanned aerial vehicle, and compares the formation error value with a preset allowable threshold value to determine whether a formation error of the unmanned aerial vehicle has occurred, wherein when it is determined that the formation error has occurred, the formation alignment unit realigns the unmanned air vehicle based on the location data of the unmanned air vehicle, and combines location data-based formation control of the unmanned air vehicle and distance data-based formation control of the unmanned air vehicle to align the unmanned air vehicle so as to maintain a constant formation form using two of the distance data.

The plurality of unmanned aerial vehicles may include a leader unmanned aerial vehicle having a flight path and formation type information for formation alignment; and a plurality of follower unmanned aerial vehicles that fly in formation around the leader unmanned aerial vehicle.

The formation alignment unit may initially align the unmanned aerial vehicle into a formation using location data-based formation control of the unmanned aerial vehicle, and then change a formation control method of the unmanned aerial vehicle to distance data-based formation control of the unmanned aerial vehicle to align the unmanned aerial vehicle so as to maintain the formation form.

Furthermore, when the formation error determination unit determines that the formation error has occurred, the formation alignment unit may change the formation control method of the unmanned air vehicle from a distance data-based method to a location data-based method to realign the unmanned air vehicle.

The formation error determination unit may calculate the overall formation error value based on a difference between location data of the unmanned aerial vehicle measured at a specific point in time and ideal location data of the unmanned aerial vehicle at the specific point in time, and determine that the formation error has occurred when the overall formation error value exceeds the allowable threshold value.

The system may further include a leader unmanned aerial vehicle location data correction unit that calculates predicted location data of the leader unmanned aerial vehicle based on location data of the follower unmanned aerial vehicle, distance data between the follower unmanned aerial vehicle and the leader unmanned aerial vehicle, and an angle between the follower unmanned aerial vehicle and the leader unmanned aerial vehicle, and corrects the location data of the leader unmanned aerial vehicle with the predicted location data.

In addition, there is provided a method of controlling a formation of an unmanned aerial vehicle including a plurality of unmanned aerial vehicles, the method including a) aligning the unmanned aerial vehicle formation with location data-based formation control of the unmanned aerial vehicle based on location data; b) aligning the unmanned aerial vehicle formation aligned based on location data to allow the unmanned aerial vehicle to maintain a formation form with distance data-based formation control of the unmanned aerial vehicle based on distance data between the plurality of unmanned aerial vehicles; c) determining whether a formation error has occurred due to formation alignment mismatch of the formation of the unmanned aerial vehicle; and d) realigning, when it is determined that the formation error has occurred, the unmanned aerial vehicle with location data-based formation control of the unmanned aerial vehicle.

The step (c) may include calculating an overall formation error value based on a difference between location data of the unmanned aerial vehicle at a specific point in time and ideal location data of the unmanned aerial vehicle at the specific point in time; and determining, when the overall formation error value exceeds the preset allowable threshold value, that the formation error has occurred.

The method may further include, subsequent to the step d), changing a formation control method of the unmanned aerial vehicle from location data-based formation control of the unmanned aerial vehicle to distance data-based formation control of the unmanned aerial vehicle to control a flight of the unmanned aerial vehicle.

The plurality of unmanned aerial vehicles may include a leader unmanned aerial vehicle having a flight path and formation type information for formation alignment, and a plurality of follower unmanned aerial vehicles that fly in formation around the leader unmanned aerial vehicle, and the method may further include calculating location data of the follower unmanned aerial vehicle, distance data between the follower unmanned aerial vehicle and the leader unmanned aerial vehicle, and an angle between the follower unmanned aerial vehicle and the leader unmanned aerial vehicle, and calculating predicted location data of the leader unmanned aerial vehicle based thereon; and correcting the location data of the leader unmanned aerial vehicle with the predicted location data.

### Advantageous Effects

According to an embodiment of the present disclosure, a formation control system may perform formation alignment based on location data of unmanned aerial vehicles, and then control a formation form to be maintained constant based on distance data of the unmanned aerial vehicles, thereby minimizing formation error accumulation that may occur in location data-based formation control as in the related art.

Accordingly, the formation control system may select location data-based formation control of unmanned aerial vehicles and distance data-based formation control of unmanned aerial vehicles depending on the situation, thereby more accurately maintaining a formation.

Furthermore, according to an embodiment of the present disclosure, the formation control system may determine in real time whether a formation error has occurred in unmanned aerial vehicles, and automatically realign a formation when it is determined that the formation error has occurred.

Additionally, according to an embodiment of the present disclosure, the formation control system may automatically calculate predicted location data of unmanned aerial vehicles, thereby correcting the location data of the unmanned aerial vehicles. Therefore, a user may efficiently control and manage a formation of unmanned aerial vehicles without separate management personnel.

In addition, according to an embodiment of the present disclosure, the formation control system may automatically control the determination of whether a formation error has occurred in unmanned aerial vehicles, formation realignment, and the like with a relatively simple configuration.

It is to be understood that the effects of the present disclosure are not limited to the foregoing effects, and include all effects that may be deduced from the features described in the detailed description or claims of the present disclosure.

### BRIEF DESCRIPTION OF THE DRAWINGS

FIG. 1 is a diagram showing an example of formation control of agricultural unmanned aerial vehicles using location coordinates according to the related art.

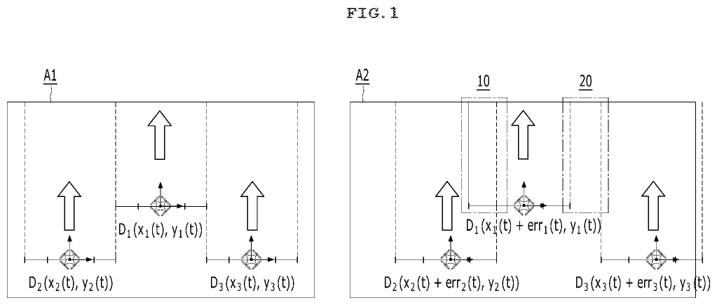

FIG. 2 is a block diagram schematically showing an unmanned aerial vehicle formation control system according to an embodiment of the present disclosure.

FIG. 3 is a block diagram showing a connection relationship between components required to control formation alignment based on the location data and distance data of unmanned aerial vehicles in an unmanned aerial vehicle formation control system according to an embodiment of the present disclosure.

FIG. 4 is a block diagram showing a connection relationship between components required to correct location data of a leader unmanned aerial vehicle in an unmanned aerial vehicle formation control system according to an embodiment of the present disclosure.

FIG. 5 is a flowchart showing a process of controlling formation alignment on unmanned aerial vehicles through a formation control system according to an embodiment of the present disclosure.

FIG. 6 is a flowchart showing a process of determining whether a formation error has occurred according to an embodiment of the present disclosure.

FIG. 7 is a diagram showing an example of calculating a formation error value of an unmanned aerial vehicle according to an embodiment of the present disclosure.

FIG. 8 is a flowchart showing a process for correcting location data of a leader unmanned aerial vehicle according to an embodiment of the present disclosure.

FIG. 9 is a diagram showing an example of calculating predicted location data of a leader unmanned aerial vehicle according to the present disclosure.

### BEST MODE FOR CARRYING OUT THE INVENTION

Hereinafter, the present disclosure will be described with reference to the accompanying drawings. However, the present disclosure may be implemented in various different forms, and therefore, is not limited to the embodiments described herein. In order to clearly describe the present disclosure, parts not related to the description are omitted, and like reference numerals designate like parts throughout the specification.

Throughout the specification, in case where a portion is “connected to (coupled to, in contact with, in combination with” the other portion, it may include a case of being “indirectly connected to” the other portion by interposing another member therebetween as well as a case of being “directly connected to” the other portion. Furthermore, when a portion may “include” a certain element, unless specified otherwise, it may not be construed to exclude another element but may be construed to further include other elements.

It should be noted that terms used herein are merely used to describe specific embodiments, but not to limit the present disclosure. As used herein, the singular forms are intended to include the plural forms as well, unless the context clearly indicates otherwise. Terms “include” or “have” used herein should be understood that they are intended to indicate the presence of a feature, a number, a step, an element, a component or a combination thereof disclosed in the specification, and it may also be understood that the presence or additional possibility of one or more other features, numbers, steps, elements, components or combinations thereof are not excluded in advance.

Hereinafter, embodiments of the present disclosure will be described in detail with reference to the accompanying drawings.

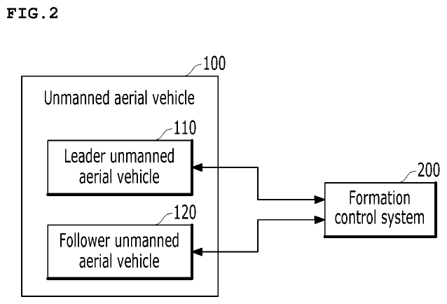

FIG. 2 is a block diagram schematically showing an unmanned aerial vehicle formation control system according to an embodiment of the present disclosure.

Referring to FIG. 2, an unmanned aerial vehicle 100 may include a leader unmanned aerial vehicle 110 and a follower unmanned aerial vehicle 120.

In an embodiment of the present disclosure, the unmanned aerial vehicle 100 may include a location measurement sensor for measuring its own location data, a distance measurement sensor for acquiring distance data with other unmanned aerial vehicles, and the like.

Additionally, the unmanned aerial vehicle 100 may include a communication device for transmitting and receiving the measured location data, distance data, and the like with other unmanned aerial vehicles. At this time, the unmanned aerial vehicle 100 may include Bluetooth, Wi-Fi, 5G, LTE, NB-IoT, LORA, or the like as a communication device, to exchange location data and distance data with the formation control system 200 in real time.

First, the leader unmanned aerial vehicle 110 may independently perform its mission by storing a flight path, a formation form, and the like for the formation alignment of the unmanned aerial vehicle 100.

In addition, the leader unmanned aerial vehicle 110 may perform a formation flight based on location data acquired by the location measurement sensor. Furthermore, the leader unmanned aerial vehicle 110 may measure distance data from the follower unmanned aerial vehicle 120 adjacent thereto using the distance measurement sensor. The leader unmanned aerial vehicle 110 may share the measured location data and distance data with the follower unmanned aerial vehicle 110 through the formation control system 200.

As will be described later, the formation control system 200 may control the formation of the unmanned aerial vehicle 100 based on a flight path, a formation form, and the like stored in the leader unmanned aerial vehicle 110. That is, the unmanned aerial vehicle 100 may fly automatically or fly while being remotely controlled in real time using the flight path, the formation form, and the like previously stored in the leader unmanned aerial vehicle 110.

Meanwhile, the follower unmanned aerial vehicle 120 may be provided in plural. Additionally, the follower unmanned aerial vehicle 120 may fly in formation around the leader unmanned aerial vehicle 110.

Likewise, the follower unmanned aerial vehicle 120 may measure location data using the location measurement sensor. Furthermore, the follower unmanned aerial vehicle 120 may acquire distance data from the leader unmanned aerial vehicle 110 at an adjacent location and distance data from the follower unmanned aerial vehicles 120 at an adjacent location using the distance measurement sensor. The follower unmanned aerial vehicle 120 may share location data and distance data through the formation control system 200.

In addition, the follower unmanned aerial vehicle 120 may perform location control based on distance data. That is, the follower unmanned aerial vehicle 120 may maintain a formation form by maintaining a constant distance from the leader unmanned aerial vehicle 110 and the follower unmanned aerial vehicle 120, which are adjacent thereto, using distance data.

The formation control system 200 may receive distance data, location data, and the like from the leader unmanned aerial vehicle 110 and the follower unmanned aerial vehicle 120. Additionally, the formation control system 200 may provide distance data, location data, and the like to the leader unmanned aerial vehicle 110 and the follower unmanned aerial vehicle 120. That is, the leader unmanned aerial vehicle 110 and the follower unmanned aerial vehicle 120 may share distance data, location data, and the like through the formation control system 200.

In addition, the formation control system 200 may receive initial location data, and a flight path, a formation form, and the like for formation alignment stored in the leader unmanned aerial vehicle 110, and align the unmanned aerial vehicle 100 based thereon. The formation control system 200 may arrange the leader unmanned aerial vehicle 110 and the follower unmanned aerial vehicle 120 in a formation form based on the location data.

Furthermore, the formation control system 200 may set the follower unmanned aerial vehicle 120 to maintain the formation form based on the distance data. That is, the formation control system 200 may align the leader unmanned aerial vehicle 110 and the follower unmanned aerial vehicle 120 into a formation form based on the location data, and control the follower unmanned aerial vehicle 120 to maintain the formation form based on the distance data.

Additionally, the formation control system 200 may determine whether a formation error of the unmanned aerial vehicle 100 has occurred in real time. The formation error may occur due to formation alignment mismatch, which causes an overall direction of the formation form of the unmanned aerial vehicle 100 to deviate. When it is determined that a formation error of the unmanned aerial vehicle 100 has occurred, the formation control system 200 may realign the unmanned aerial vehicle 100 based on the location data.

The formation control system 200 may receive time-dependent location data of the leader unmanned aerial vehicle 110 and the follower unmanned aerial vehicle 120 constituting the unmanned aerial vehicle 100, and compare the received location data with ideal location data at that point in time to calculate a formation error value.

The formation control system may add up all formation error values of the leader unmanned aerial vehicle 110 and the follower unmanned aerial vehicle 120, and scalarize them to calculate an overall formation error value.

Additionally, the formation control system 200 may compare the overall formation error value with a preset allowable threshold value to determine whether a formation error has occurred. When it is determined that a formation error has occurred, the formation control system 200 may realign the leader unmanned aerial vehicle 110 and the follower unmanned aerial vehicle 120 based on location data. That is, when it is determined that a formation error has occurred, the formation control system 200 may switch from controlling a formation based on distance data to controlling the formation based on location data.

In addition, the formation control system 200 may realign the leader unmanned aerial vehicle 110 and the follower unmanned aerial vehicle 120 based on location data, and then switch back to performing formation control based on distance data.

Furthermore, the formation control system 200 may calculate a predicted location value of the leader unmanned aerial vehicle 110 according to each follower unmanned aerial vehicle 120, and calculate predicted location data of the leader unmanned aerial vehicle 110 based thereon to correct the location data of the leader unmanned aerial vehicle 110.

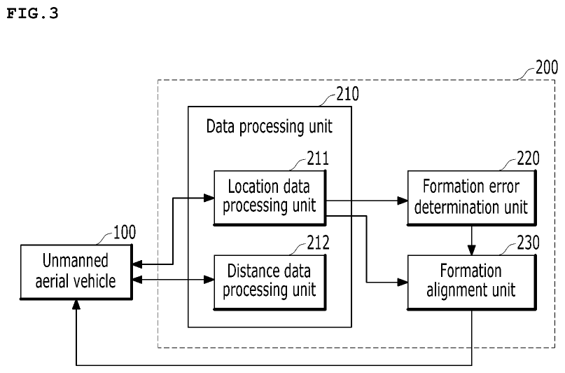

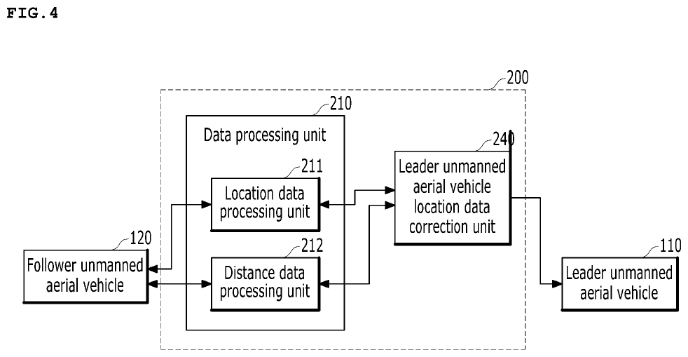

Hereinafter, a specific operation of the formation control system 200 will be described in detail with reference to FIGS. 3 and 4.

FIG. 3 is a block diagram showing a connection relationship between components required to control formation alignment based on the location data and distance data of unmanned aerial vehicles in an unmanned aerial vehicle formation control system according to an embodiment of the present disclosure.

As shown in FIG. 3, the formation control system 200 may include a data processing unit 210, a formation error determination unit 220, and a formation alignment unit 230.

First, the data processing unit 210 may include a location data processing unit 211 and a distance data processing unit 212.

The location data processing unit 211 may receive location data of the leader unmanned aerial vehicle and the follower unmanned aerial vehicle included in the unmanned aerial vehicle from the unmanned aerial vehicle 100. The location data refers to location data expressed in absolute coordinates such as GPS information. The location data processing unit 211 may provide the received location data to the unmanned aerial vehicle 100, thereby allowing the leader unmanned aerial vehicle and the follower unmanned aerial vehicle to share the location data.

In addition, the distance data processing unit 212 may receive distance data of the leader unmanned aerial vehicle and the follower unmanned aerial vehicle included in the unmanned aerial vehicle from the unmanned aerial vehicle 100. The distance data is data that measures a distance between unmanned aerial vehicles using a distance sensor attached to each unmanned aerial vehicle.

The distance data processing unit 212 may provide the received distance data to the unmanned aerial vehicle 100, thereby allowing the leader unmanned aerial vehicle and the follower unmanned aerial vehicle to share the distance data. Accordingly, the follower unmanned aerial vehicle may receive the distance data of the leader unmanned aerial vehicle and the distance data of other follower unmanned aerial vehicles from the distance data processing unit 212, thereby maintaining a constant formation form based on the distance data.

The distance data-based formation control of the unmanned aerial vehicle 100 usually results in a formation error of up to ±0.1 m. Since the unmanned aerial vehicle 100 according to an embodiment of the present disclosure can maintain a formation form using distance data after its initial location is set based on location data, a formation error may be minimized compared to location data-based formation control.

Meanwhile, when maintaining the formation form using distance data, even though a distance between each unmanned aerial vehicle is maintained, a formation error may occur due to a mismatch in formation alignment that causes an overall direction of the formation form to deviate. For this purpose, there is a need to determine whether a formation error has occurred and realign the formation.

The formation error determination unit 220 may receive location data of the unmanned aerial vehicle 100 from the location data processing unit 210 in real time. The formation error determination unit 220 may determine whether a formation error has occurred based on the location data.

For example, the formation error determination unit 220 may calculate a formation error value using the location data of the unmanned aerial vehicle 100 received in real time and ideal location data of the unmanned aerial vehicle 100 at the corresponding point in time. For example, the formation error determination unit 220 may calculate a difference between the real-time measured location data of the leader unmanned aerial vehicle and the follower unmanned aerial vehicle included in the unmanned aerial vehicle 100 and the ideal location data of each of the leader unmanned aerial vehicle and the follower unmanned aerial vehicle at that point in time as a formation error value. At this time, the formation error value may be derived for each of the leader unmanned aerial vehicle and the follower unmanned aerial vehicle.

Furthermore, the formation error determination unit 220 may add up all the calculated formation error values, and scalarize them to calculate an overall formation error value. That is, the formation error value calculated in the embodiment of the present disclosure is numerically expressed as an amount of error in an overall location of the formation compared to the ideal location data of the unmanned aerial vehicle.

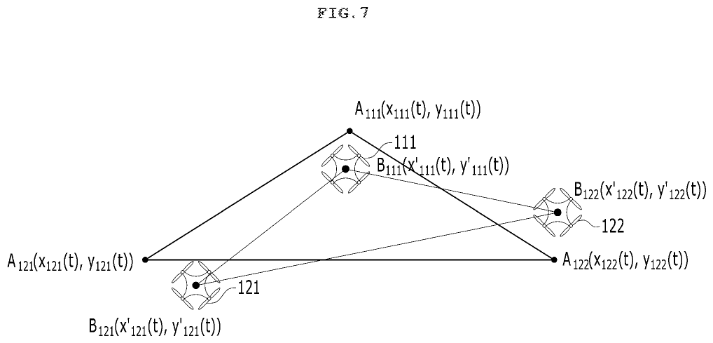

The determination of a specific formation error and the calculation of a formation error value will be described in detail later with reference to FIG. 7.

Accordingly, the formation error determination unit 220 may compare the overall formation error value with a preset allowable threshold value to determine whether a formation error has occurred. When the overall formation error value exceeds the allowable threshold value, the formation error determination unit 220 may determine that a formation error has occurred.

Therefore, a formation error value may be an indicator capable of checking a difference between a formation form of the unmanned aerial vehicle 100 measured in real time and an ideal formation form of the unmanned aerial vehicle 100.

The formation alignment unit 230 may receive a flight path, a formation form, and the like for formation alignment stored in the unmanned aerial vehicle 100. In addition, the formation alignment unit 230 may receive initial location data of the unmanned aerial vehicle 100 from the location data processing unit 211.

The formation alignment unit 230 may align the unmanned aerial vehicle 100 based on the received initial location data, flight path, formation form, and the like. As will be described later, the formation alignment unit 230 may align the unmanned aerial vehicle 100 based on initial location data, and then set the unmanned aerial vehicle 100 to maintain the formation form based on the distance data.

At this time, the leader unmanned aerial vehicle may fly based on location data, and the follower unmanned aerial vehicle may perform a distance data-based flight around the leader unmanned aerial vehicle 110. Since the follower unmanned aerial vehicle is aligned into a formation form based on location data and then maintains the formation form based on distance data, it may be possible to maintain a constant formation using only two distance data including distance data with respect to an adjacent leader unmanned aerial vehicle or distance data with respect to an adjacent follower unmanned aerial vehicle.

Moreover, when the leader unmanned aerial vehicle and the follower unmanned aerial vehicle fly at the same altitude, the follower unmanned aerial vehicle may maintain a formation form using only two distance data including distance data with respect to an adjacent leader unmanned aerial vehicle or distance data with respect to an adjacent follower unmanned aerial vehicle even in a three-dimensional space.

Additionally, when the formation error determination unit 230 determines that a formation error has occurred, the formation alignment unit 230 may realign the formation of the unmanned aerial vehicle 100 based on the location data of the unmanned aerial vehicle 100.

That is, when a formation error has occurred, the formation alignment unit 230 may switch the unmanned aerial vehicle 100, which has been controlled based on distance data, to be controlled based on location data.

Additionally, the formation alignment unit 230 may realign the unmanned aerial vehicle 100 based on location data, and then switch back to controlling the unmanned aerial vehicle 100 based on distance data.

FIG. 4 is a block diagram showing a connection relationship between components required to correct location data of a leader unmanned aerial vehicle in an unmanned aerial vehicle formation control system according to an embodiment of the present disclosure.

The formation control system 200 may further include a leader unmanned aerial vehicle location data correction unit 240. When formation control is performed based on distance data, the formation error is very small, up to ±0.1 m. Therefore, when the distance data-based formation error is excluded, only the location data-based formation error of the leader unmanned aerial vehicle 110 may be involved in formation flight.

Therefore, the formation control system 200 according to an embodiment of the present disclosure may correct a location data error of the leader unmanned aerial vehicle 110, thereby minimizing a formation error during flight.

First, the location data processing unit 211 may receive location data from the follower unmanned aerial vehicle 120.

Furthermore, the distance data processing unit 211 may receive distance data between the follower unmanned aerial vehicle 120 and the leader unmanned aerial vehicle 110 from the follower unmanned aerial vehicle 120.

The leader unmanned aerial vehicle location data correction unit 240 may receive location data and distance data, and calculate predicted location data of the leader unmanned aerial vehicle based on the location data and distance data.

For an example, the leader unmanned aerial vehicle location data correction unit 240 may receive location data and distance data from a plurality of follower unmanned aerial vehicles 120. The location data may include location coordinates of a plurality of follower unmanned aerial vehicles 120 measured in real time. Additionally, the distance data may include distances between the plurality of follower unmanned aerial vehicles 120 and the leader unmanned aerial vehicle 110 measured in real time.

In addition, the leader unmanned aerial vehicle location data correction unit 240 may calculate an angle between each of the follower unmanned aerial vehicles 120 and the leader unmanned aerial vehicle 110 using the location data of the follower unmanned aerial vehicles 120 and the distance data between the follower unmanned aerial vehicles 120 and the leader unmanned aerial vehicle 110.

The leader unmanned aerial vehicle location data correction unit 240 may calculate a predicted location value of the leader unmanned aerial vehicle 110 with respect to each of the follower unmanned aerial vehicles 120 using location data of the follower unmanned aerial vehicles 120, distance data between the follower unmanned aerials vehicles 120 and the leader unmanned aerial vehicle 110, and an angle between each of the follower unmanned aerial vehicles 120 and the leader unmanned aerial vehicle 110.

In addition, the leader unmanned aerial vehicle location data correction unit 240 may calculate an average of the predicted location values of the leader unmanned aerial vehicle 110 in each of the follower unmanned aerial vehicles 120, and determine the calculated average as the predicted location data of the leader unmanned aerial vehicle 110.

Additionally, the leader unmanned aerial vehicle location data correction unit 240 may correct the location data of the leader unmanned aerial vehicle 110 with the predicted location data of the leader unmanned aerial vehicle 110.

Accordingly, the leader unmanned aerial vehicle location data correction unit 240 may correct the location data of the leader unmanned aerial vehicle 110 in real time, thereby preventing a location data error of the leader unmanned aerial vehicle 110 caused by an external environment.

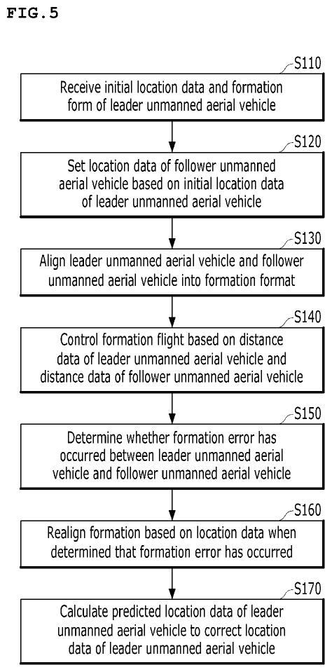

FIG. 5 is a flowchart showing a process of controlling formation alignment on unmanned aerial vehicles through a formation control system according to an embodiment of the present disclosure.

In step S110, the formation control system may receive initial location data, a flight path, a formation form, and the like from the leader unmanned aerial vehicle. In the leader unmanned aerial vehicle, initial location data, a flight path and a formation form for formation alignment, and the like may be stored in advance or input in real time through remote control.

In step S120, the formation control system may set the location data of the follower unmanned aerial vehicle based on the initial location data of the leader unmanned aerial vehicle. The formation control system may set location data to achieve an ideal formation form by referring the location data of the follower unmanned aerial vehicle to the initial location data of the leader unmanned aerial vehicle. That is, the formation control system may set the follower unmanned aerial vehicle based on the initial location data of the leader unmanned aerial vehicle, thereby setting a formation direction to allow the follower unmanned aerial vehicle and the leader unmanned aerial vehicle to face the same direction.

In step S130, the formation control system may align the leader unmanned aerial vehicle and the follower unmanned aerial vehicle into a formation form. The formation control system may align the locations of the leader unmanned aerial vehicle and the follower unmanned aerial vehicle in the formation format received from the leader unmanned aerial vehicle. The formation control system may provide formation-type location data to the leader unmanned aerial vehicle and the follower unmanned aerial vehicle, thereby setting the location data of each of the leader unmanned aerial vehicle and the follower unmanned aerial vehicle formation-type location data.

In step S140, the formation control system may control the formation flight of the leader unmanned aerial vehicle and the follower unmanned aerial vehicle based on the distance data of the leader unmanned aerial vehicle and the distance data of the follower unmanned aerial vehicle.

The formation control system may provide distance data to the leader unmanned aerial vehicle and the follower unmanned aerial vehicle, thereby allowing the leader unmanned aerial vehicle and the follower unmanned aerial vehicle to share the distance data. Therefore, the follower unmanned aerial vehicle may fly in formation while maintaining a predetermined distance from an adjacent leader unmanned aerial vehicle and an adjacent follower unmanned aerial vehicle based on the received distance data.

That is, the formation control system may set the location data of the leader unmanned aerial vehicle and the follower unmanned aerial vehicle in step S130, and control the follower unmanned aerial vehicle to fly in formation based on the distance data in this step.

Furthermore, since the follower unmanned aerial vehicle is aligned into a formation form based on location data to maintain the formation form based on distance data, it may be possible to maintain a constant formation using only two distance data including distance data with respect to an adjacent leader unmanned aerial vehicle and distance data with respect to an adjacent follower unmanned aerial vehicle.

The formation control system may set the location data of the leader unmanned aerial vehicle and the follower unmanned aerial vehicle and perform formation control based on the distance data, thereby allowing the leader unmanned aerial vehicle and the follower unmanned aerial vehicle to fly in a unique formation model while maintaining a predetermined distance for a formation flight.

Meanwhile, a formation error may occur during flight in unmanned aerial vehicles aligned in formation in steps S110 to S140. For example, when an entire formation makes a U-turn for pesticide spraying, or the like, a distance between unmanned aerial vehicles may be maintained, but an ideal direction of the formation form may be deviated.

In step S150, the formation control system determines whether a formation error has occurred between the leader unmanned aerial vehicle and the follower unmanned aerial vehicle.

The formation control system may receive the location data of the leader unmanned aerial vehicle and the location data of the follower unmanned aerial vehicle in real time to determine whether a formation error has occurred.

The formation control system may calculate a formation error value based on the location data of the leader unmanned aerial vehicle and the location data of the follower unmanned aerial vehicle received in real time, and the ideal location data of the leader unmanned aerial vehicle and the location data of the follower unmanned aerial vehicle at that point in time. The formation error value is calculated by comparing a formation form generated from the location data at that time point with an ideal formation form.

In addition, the formation control system may add up all formation error values of the leader unmanned aerial vehicle and the follower unmanned aerial vehicle that form a formation to calculate an overall formation error value. The formation control system may determine whether a formation error has occurred by comparing the overall formation error value with a preset allowable threshold value.

In step S160, when it is determined that a formation error has occurred, the formation control system may realign a formation based on location data.

When it is determined that a formation error has occurred, the formation control system may realign the formation based on the location data of the leader unmanned aerial vehicle and the follower unmanned aerial vehicle that form the formation. That is, the formation control system may reset the shifted location data of the leader unmanned aerial vehicle and the follower unmanned aerial vehicle to a pre-registered formation form. That is, when a formation error has occurred, the formation control system may switch from controlling the formation of the unmanned aerial vehicle based on distance data to location data-based formation control.

Additionally, the formation control system may realign the unmanned aerial vehicle based on location data, and then switch back to distance-based data formation control. As a result, the formation control system may more precisely control the unmanned aerial vehicle to be aligned in formation.

In step S170, the formation control system may calculate predicted location data of the leader unmanned aerial vehicle.

The formation control system may calculate a predicted location value of the leader unmanned aerial vehicle based on location data of the follower unmanned aerial vehicle, distance data between the follower unmanned aerial vehicle and the leader unmanned aerial vehicle, and an angle between the follower unmanned aerial vehicle and the leader unmanned aerial vehicle. At this time, the formation control system may calculate the predicted location value of the leader unmanned aerial vehicle for each follower unmanned aerial vehicle that forms the formation.

Furthermore, the formation control system may calculate an average of the predicted location values of the leader unmanned aerial vehicle in each follower unmanned aerial vehicle that forms the formation, and determine the calculated average as the predicted location data of the leader unmanned aerial vehicle.

Additionally, the formation control system may provide the predicted location data of the leader unmanned aerial vehicle to the leader unmanned aerial vehicle, thereby correcting the location data of the leader unmanned aerial vehicle to maintain the formation form.

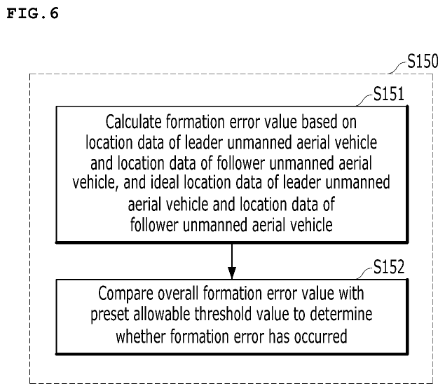

FIG. 6 is a flowchart showing a process of determining whether a formation error has occurred according to an embodiment of the present disclosure.

In step S151, the formation control system may calculate a formation error value based on the location data of the leader unmanned aerial vehicle and the location data of the follower unmanned aerial vehicle, and the ideal location data of the leader unmanned aerial vehicle and the location data of the follower unmanned aerial vehicle.

For example, the formation control system may calculate a difference between each location data of the leader unmanned aerial vehicle received in real time and the ideal location data of the leader unmanned aerial vehicle as a formation error value of the leader unmanned aerial vehicle. Likewise, a difference between the location data of each follower unmanned aerial vehicle that forms a formation and the ideal location data of the follower unmanned aerial vehicle may be calculated as a formation error value of each follower unmanned aerial vehicle.

The ideal location data of the leader unmanned aerial vehicle and the follower unmanned aerial vehicle may be derived based on a preset formation form and flight path of the corresponding follower unmanned aerial vehicle.

In addition, the formation control system may add up all formation error values of each of the leader unmanned aerial vehicle and the follower unmanned aerial vehicle, and generalize them to a scalar value to calculate an overall formation error value.

In step S152, the formation control system may compare the overall formation error value with a preset allowable threshold value to determine whether a formation error has occurred. The formation control system may determine that a formation error has occurred when the overall formation error value exceeds the allowable threshold value.

FIG. 7 is a diagram showing an example of calculating a formation error value of an unmanned aerial vehicle according to an embodiment of the present disclosure.

Referring to FIG. 7, a leader unmanned aerial vehicle 111 and follower unmanned aerial vehicles 121, 122 may form a formation. At this time, the formation control system may derive ideal location data of the leader unmanned aerial vehicle 111 and the follower unmanned aerial vehicles 121, 122 based on the pre-registered flight path and formation form. Furthermore, the formation control system may receive measured location data of each of the leader unmanned aerial vehicle 111 and the follower unmanned aerial vehicles 121, 122.

Additionally, the formation control system may compare the ideal location data of each of the leader unmanned aerial vehicle 111 and the follower unmanned aerial vehicles 121, 122 with the measured location data to calculate a formation error value.

As shown in FIG. 7, the formation control system may express the ideal location data of the leader unmanned aerial vehicle 111 at time t as A₁₁₁(x₁₁₁(t), y₁₁₁(t)). In addition, the formation control system may express the ideal location data of each of the follower unmanned aerial vehicle 121 and the follower unmanned aerial vehicle 122 at time t as A₁₂₁(x₁₂₁(t), y₁₂₁(t)) and A₁₂₂(x₁₂₂(t), y₁₂₂(t)).

Furthermore, the formation control system may express the location data of the leader unmanned aerial vehicle 111 measured at time t as B₁₁₁(x′₁₁₁(t), y′₁₁₁(t)) Likewise, the formation control system may express the location data of the follower unmanned aerial vehicle 121 measured at time t as B₁₂₁(x′₁₂₁(t), y′₁₂₁(t)) and the location data of the follower unmanned aerial vehicle 122 measured at time t as B₁₂₂(x′₁₂₂(t), y′₁₂₂(t)).

The formation control system may calculate a difference between the ideal location data A₁₁₁(x₁₁₁(t), y₁₁₁(t)) of the leader unmanned aerial vehicle at time t and the location data B₁₁₁(x′₁₁₁(t), y′₁₁₁(t)) thereof measured at time t as a formation error value.

Likewise, a difference between the ideal location data of each of the follower unmanned aerial vehicle 121 and the follower unmanned aerial vehicle 122 at time t and the location data thereof measured at time t may be calculated as a formation error value for each of the follower unmanned aerial vehicles 121, 122.

The formation control system may add up all formation error values of each of the leader unmanned aerial vehicle 111 and the follower unmanned aerial vehicle 122, and scalarize them to calculate an overall formation error value.

The formation control system may compare the overall formation error value with a preset allowable threshold value. The formation control system may determine that a formation error has occurred when the overall formation error value exceeds the allowable threshold value.

In addition, when it is determined that a formation error has occurred, the formation control system may reset the location data of each of the leader unmanned aerial vehicle 111 and follower unmanned aerial vehicles 121, 122 to a pre-registered formation form.

Therefore, the formation control system may correct a formation error based on the location data of the leader unmanned aerial vehicle 111 and the follower unmanned aerial vehicles 121, 122, thereby realigning the leader unmanned aerial vehicle 111 and the follower unmanned aerial vehicles 121, 122 into a formation form.

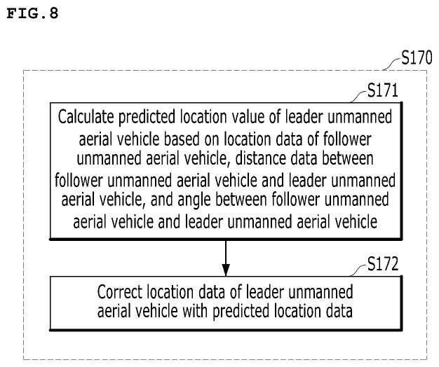

FIG. 8 is a flowchart showing a process for correcting location data of a leader unmanned aerial vehicle according to an embodiment of the present disclosure.

In step S171, the formation control system may calculate the predicted location value of the leader unmanned aerial vehicle for each follower unmanned aerial vehicle that forms a formation.

The formation control system may receive location data of the follower unmanned aerial vehicle and distance data between the follower unmanned aerial vehicle and the leader unmanned aerial vehicle from the follower unmanned aerial vehicle.

Additionally, the formation control system may calculate an angle between the leader unmanned aerial vehicle and the follower unmanned aerial vehicle based on a pre-registered formation form.

The formation control system may calculate a predicted location value of the leader unmanned aerial vehicle using location data of the follower unmanned aerial vehicle, distance data between the follower unmanned aerial vehicle and the leader unmanned aerial vehicle, and an angle between the follower unmanned aerial vehicle and the leader unmanned aerial vehicle. Furthermore, the formation control system may calculate the predicted location value of the leader unmanned aerial vehicle in all follower unmanned aerial vehicles that form a formation.

In step S172, the formation control system may correct the predicted location data of the leader unmanned aerial vehicle with the location data of the leader unmanned aerial vehicle.

The formation control system may calculate an average of the predicted location values of the leader unmanned aerial vehicle for each follower unmanned aerial vehicle, and determine the calculated average as the predicted location data of the leader unmanned aerial vehicle.

In addition, the formation control system may correct the predicted location data of the leader unmanned aerial vehicle with the location data of the leader unmanned aerial vehicle.

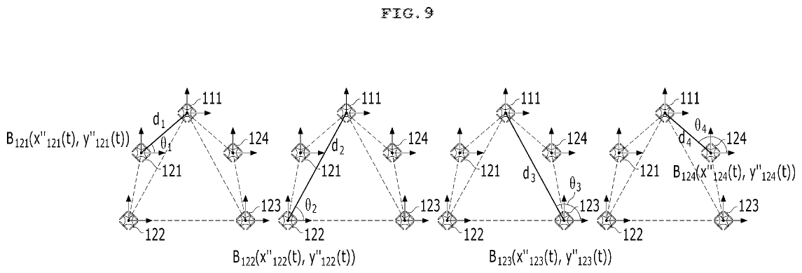

FIG. 9 is a diagram showing an example of calculating predicted location data of a leader unmanned aerial vehicle according to the present disclosure.

Referring to FIG. 9, a leader unmanned aerial vehicle 111 and follower unmanned aerial vehicles 121, 122, 123, 124 may form a formation. The formation control system may calculate the predicted location value of the leader unmanned aerial vehicle 111 for each of the follower unmanned aerial vehicles 121, 122, 123, 124.

For example, the formation control system may receive location data (B₁₂₁(x″₁₂₁(t), y″₁₂₁(t))) of the follower unmanned aerial vehicle 122 and distance data d₁ between the follower unmanned aerial vehicle 121 and the leader unmanned aerial vehicle 111 from the follower unmanned aerial vehicle 121.

In addition, the formation control system may obtain an angle θ₁ between the follower unmanned aerial vehicle 121 and the r unmanned aerial vehicle 111 based on a pre-registered formation form.

Likewise, the formation control system may obtain location data (B(x″₁₂₂(t), y″₁₂₂(t))) of the follower unmanned aerial vehicle 122, distance data d₂ between the follower unmanned aerial vehicle 122 and the leader unmanned aerial vehicle 111, and an angle θ₂ between the follower unmanned aerial vehicle 122 and the leader unmanned aerial vehicle 111. In addition, the formation control system may obtain location data (B₁₂₃(x″₁₂₃(t), y″₁₂₃(t))) of the follower unmanned aerial vehicle 123, distance data d₃ between the follower unmanned aerial vehicle 123 and the leader unmanned aerial vehicle 111, and an angle θ₃ between the follower unmanned aerial vehicle 123 and the leader unmanned aerial vehicle. The formation control system may obtain location data (B₁₂₄(x″₁₂₄(t), y″₁₂₄(t))) of the follower unmanned aerial vehicle 124, distance data d₄ between the follower unmanned aerial vehicle 124 and the leader unmanned aerial vehicle 111, and an angle θ₄ between the follower unmanned aerial vehicle 124 and the leader unmanned aerial vehicle 111.

The formation control system may calculate a predicted location value of the leader unmanned aerial vehicle 111 using location data of each of the follower unmanned aerial vehicles 121, 122, 123, 124, distance data between the follower unmanned aerial vehicles 121, 122, 123, 124 and the leader unmanned aerial vehicle 111, and angles between the follower unmanned aerial vehicles 121, 122, 123, 124 and the leader unmanned aerial vehicle 111.

The formation control system may calculate an expected location value

$${A}_{L}^{121}$$

of the leader unmanned aerial vehicle 111 in location value the follower unmanned aerial vehicle 121 as

$${A}_{L}^{121} = ( {x}_{121}^{′′} ( t ) + {d}_{1} cos {θ}_{1} , {y}_{121}^{′′} ( t ) + {d}_{1} sin {θ}_{1} ) .$$

Likewise, the formation control system may calculate expected location values

$${A}_{L}^{122} , {A}_{L}^{123} and {A}_{L}^{124}$$

of the leader unmanned aerial vehicle 111 for each of the follower unmanned aerial vehicles 122, 123, 124 as

$${A}_{L}^{121} = ( {x}_{121}^{′′} ( t ) + {d}_{1} cos {θ}_{1} , {y}_{121}^{′′} ( t ) + {d}_{1} sin {θ}_{1} ) ,$$

$${A}_{L}^{123} = ( {x}_{123}^{′′} ( t ) + {d}_{3} cos {θ}_{3} , {y}_{123}^{′′} ( t ) + {d}_{3} sin {θ}_{3} )$$

$$and$$

$${A}_{L}^{124} = ( {x}_{124}^{′′} ( t ) + {d}_{4} cos {θ}_{4} , {y}_{124}^{′′} ( t ) + {d}_{4} sin {θ}_{4} ) .$$

Furthermore, the formation control system may correct the location data of the leader unmanned aerial vehicle 111 with an x-coordinate average and a y-coordinate average of the expected location values

$${A}_{L}^{121} , {A}_{L}^{122} , {A}_{L}^{123} and {A}_{L}^{124}$$

of the leader unmanned aerial vehicle 111 for each of the follower unmanned aerial vehicles 121, 122, 123, 124.

The formation control system may calculate the location data of the leader unmanned aerial vehicle as

$$\frac{1}{4} ( ( {x}_{121}^{′′} ( t ) + {d}_{1} cos {θ}_{1} ) + ( {x}_{122}^{′′} ( t ) + {d}_{2} cos {θ}_{2} ) + ( {x}_{123}^{′′} ( t ) + {d}_{3} cos {θ}_{3} ) + ( {x}_{124}^{′′} ( t ) + {d}_{4} cos {θ}_{4} ) , ( {y}_{121}^{′′} ( t ) + {d}_{1} sin {θ}_{1} ) + ( {y}_{122}^{′′} ( t ) + {d}_{2} sin {θ}_{2} ) + ( {y}_{123}^{′′} ( t ) + {d}_{3} sin {θ}_{3} ) + ( {y}_{124}^{′′} ( t ) + {d}_{4} sin {θ}_{4} ) ) .$$

That is, the formation control system may calculate the location data of the leader unmanned aerial vehicle based on an equation of

$$\frac{1}{k - i + 1} {\sum }_{i = 121}^{k} {A}_{L}^{i} .$$

Therefore, the formation control system may correct the location data of the leader unmanned aerial vehicle in real time, thereby minimizing a formation error.

Moreover, an effect capable of controlling the leader unmanned aerial vehicle with more accurate location data may be expected without having to install expensive GPS equipment with high precision.

The foregoing description of the present disclosure is for illustrative purposes, but it will be apparent to those skilled in the art to which the invention pertains that the invention can be easily modified in other specific forms without departing from the technical concept and essential characteristics thereof. Therefore, it should be understood that embodiments described above are merely illustrative but not restrictive in all aspects. For example, each element described as a single entity may be distributed and implemented, and likewise, elements described as being distributed may also be implemented in a combined manner.

The scope of the present disclosure is defined by the appended claims, and all changes or modifications derived from the meaning and range of the claims and equivalents thereof should be construed to be embraced by the scope of the present disclosure.

The modes for carrying out the present disclosure have been described together with the best modes for carrying out the present disclosure.

An unmanned aerial vehicle formation system according to an embodiment of the present disclosure may automatically calculate predicted location data of unmanned aerial vehicles, thereby correcting the location data of the unmanned aerial vehicles, and therefore, a user may efficiently control and manage a formation of unmanned aerial vehicles without separate management personnel, and the formation control system may automatically control the determination of whether a formation error has occurred in the unmanned aerial vehicles, formation realignment, and the like with a relatively simple configuration.

1. An unmanned aerial vehicle formation control system that performs formation control of a plurality of unmanned aerial vehicles, the system comprising:
a data processing unit that receives the location data and distance data of the unmanned aerial vehicles and provides the received location data and distance data to other unmanned aerial vehicles belonging to a formation of the unmanned aerial vehicles;
a formation alignment unit that selectively uses the location data and the distance data to align the formation of the unmanned aerial vehicles; and
a formation error determination unit that calculates an overall formation error value due to formation alignment mismatch based on the location data of the unmanned aerial vehicle, and compares the formation error value with a preset allowable threshold value to determine whether a formation error of the unmanned aerial vehicle has occurred,
wherein when it is determined that the formation error has occurred, the formation alignment unit realigns the unmanned air vehicle based on the location data of the unmanned air vehicle, and combines location data-based formation control of the unmanned air vehicle and distance data-based formation control of the unmanned air vehicle to align the unmanned air vehicle so as to maintain a constant formation form using two of the distance data.

2. The system of claim 1, wherein the plurality of unmanned aerial vehicles comprise a leader unmanned aerial vehicle having a flight path and formation type information for formation alignment; and
a plurality of follower unmanned aerial vehicles that fly in formation around the leader unmanned aerial vehicle.

3. The system of claim 1, wherein the formation alignment unit initially aligns the unmanned aerial vehicle into a formation using location data-based formation control of the unmanned aerial vehicle, and then changes a formation control method of the unmanned aerial vehicle to distance data-based formation control of the unmanned aerial vehicle to align the unmanned aerial vehicle so as to maintain the formation form.

4. The system of claim 3, wherein when the formation error determination unit determines that the formation error has occurred, the formation alignment unit changes the formation control method of the unmanned air vehicle from a distance data-based method to a location data-based method to realign the unmanned air vehicle.

5. The system of claim 4, wherein the formation error determination unit calculates the overall formation error value based on a difference between location data of the unmanned aerial vehicle measured at a specific point in time and ideal location data of the unmanned aerial vehicle at the specific point in time, and determines that the formation error has occurred when the overall formation error value exceeds the allowable threshold value.

6. The system of claim 2, further comprising:
a leader unmanned aerial vehicle location data correction unit that calculates predicted location data of the leader unmanned aerial vehicle based on location data of the follower unmanned aerial vehicle, distance data between the follower unmanned aerial vehicle and the leader unmanned aerial vehicle, and an angle between the follower unmanned aerial vehicle and the leader unmanned aerial vehicle, and corrects the location data of the leader unmanned aerial vehicle with the predicted location data.

7. A method of controlling a formation of an unmanned aerial vehicle including a plurality of unmanned aerial vehicles, the method comprising:
a) aligning the unmanned aerial vehicle formation with location data-based formation control of the unmanned aerial vehicle based on location data;
b) aligning the unmanned aerial vehicle formation aligned based on location data to allow the unmanned aerial vehicle to maintain a formation form with distance data-based formation control of the unmanned aerial vehicle based on distance data between the plurality of unmanned aerial vehicles;
c) determining whether a formation error has occurred due to formation alignment mismatch of the formation of the unmanned aerial vehicle; and
d) realigning, when it is determined that the formation error has occurred, the unmanned aerial vehicle with location data-based formation control of the unmanned aerial vehicle.

8. The method of claim 7, wherein the step (c) comprises:
calculating an overall formation error value based on a difference between location data of the unmanned aerial vehicle at a specific point in time and ideal location data of the unmanned aerial vehicle at the specific point in time; and
determining, when the overall formation error value exceeds the preset allowable threshold value, that the formation error has occurred.

9. The method of claim 8, further comprising:
subsequent to the step d),
changing a formation control method of the unmanned aerial vehicle from location data-based formation control of the unmanned aerial vehicle to distance data-based formation control of the unmanned aerial vehicle to control a flight of the unmanned aerial vehicle.

10. The method of claim 7, wherein the plurality of unmanned aerial vehicles comprise a leader unmanned aerial vehicle having a flight path and formation type information for formation alignment; and
a plurality of follower unmanned aerial vehicles that fly in formation around the leader unmanned aerial vehicle, the method further comprising:
calculating location data of the follower unmanned aerial vehicle, distance data between the follower unmanned aerial vehicle and the leader unmanned aerial vehicle, and an angle between the follower unmanned aerial vehicle and the leader unmanned aerial vehicle, and calculating predicted location data of the leader unmanned aerial vehicle based thereon; and
correcting the location data of the leader unmanned aerial vehicle with the predicted location data.
